(19) United States
(12) Patent Application Publication
(10) Pub. No.: US 2012/0190413 A1
(43) Pub. Date: Jul. 26, 2012

(54) Cell phone belt pack

(76) Inventor: Helen Ojeda, Hemet, CA (US)

(21) Appl. No.: 13/373,939

(22) Filed: Dec. 5, 2011

Related U.S. Application Data
(60) Provisional application No. 61/458,945, filed on Dec. 3, 2010.

(51) Int. Cl. H04M 1/00; H04W 88/02

(52) U.S. Cl. 455/575.8

(57) ABSTRACT

The invention provides a belt featuring an integrated storage case for use with cellular telephones, comprising the belt itself, a lightweight and comfortable waist belt manufactured primarily of stretchy elastic material. Incorporated into the design of the Cell Phone Belt Pack is the actual cell phone holder. Reinforced, this holder is manufactured of molded and shatterproof plastic or rubber material, or can be manufactured of the same material as the belt itself and is securely attached to the surface of the belt in an easily accessed location, such as on the hip. The holder is generally rectangular in shape and sized appropriately to accommodate the various makes and models of cellular telephones available on the market. The top of this holder is a flap like covering, held closed by means of self affixing magnetic fasteners which secure the cell phone within.

### CLAIM OF PRIORITY

This patent application claims priority under 35 USC 119(e) (1) from U.S. Provisional Patent Application Ser. No. 61/458,945 filed Dec. 3, 2010, of Mary Helen Ojeda, “Cell Phone belt Pack.”

### FIELD OF THE INVENTION

The present invention pertains to the field of cell phone utilities and more specifically to the field of cell phone storage.

### BACKGROUND OF THE INVENTION

The prior art has put forth several designs for cell phone storage. Among these are:

### FIELD OF THE INVENTION

The present invention pertains to the field of cell phone accessories and more specifically to the field of cell phone storage.

### BACKGROUND OF THE INVENTION

The prior art has put forth several designs for cell phone storage. Among these are:

U.S. Pat. No. 6,454,146 to Joshua M. Alis describes a Cell phone holder comprising a pocket having an open end which wraps around the wearer's belt.

U.S. Pat. No. 6,568,576 to Donald E. Godshaw and Andrezj E. Redzisz describes a Cell phone pouch for holding the cell phone and an elongate strap for wearing over the shoulder.

U.S. Pat. No. 6,651,854 to Marvin LaCoste describes a cell phone carrier apparatus comprising a pocket for receiving the cell phone, the pocket having an orifice for the antenna of the cell phone to protrude therethrough and an upper flap member which includes a vertical slot therein for allowing a belt loop of pants or like garment to fit therethrough.

U.S. Pat. No. 6,695,189 to Michael Dolas describes an accessory pocket for attaching to a belt for receiving articles, such as personal communication devices.

None of these prior art references describe the present invention.

### SUMMARY OF THE INVENTION

It is an object of the present invention to provide an improved means for carrying a cell phone on a belt or strap.

### BRIEF DESCRIPTION OF THE DRAWINGS

FIG. 1 is a front perspective view of the belt of the present invention showing the cell phone pocket attached thereto.

FIG. 2 is a close up of the cell pocket of the present invention showing the magnetic closure.

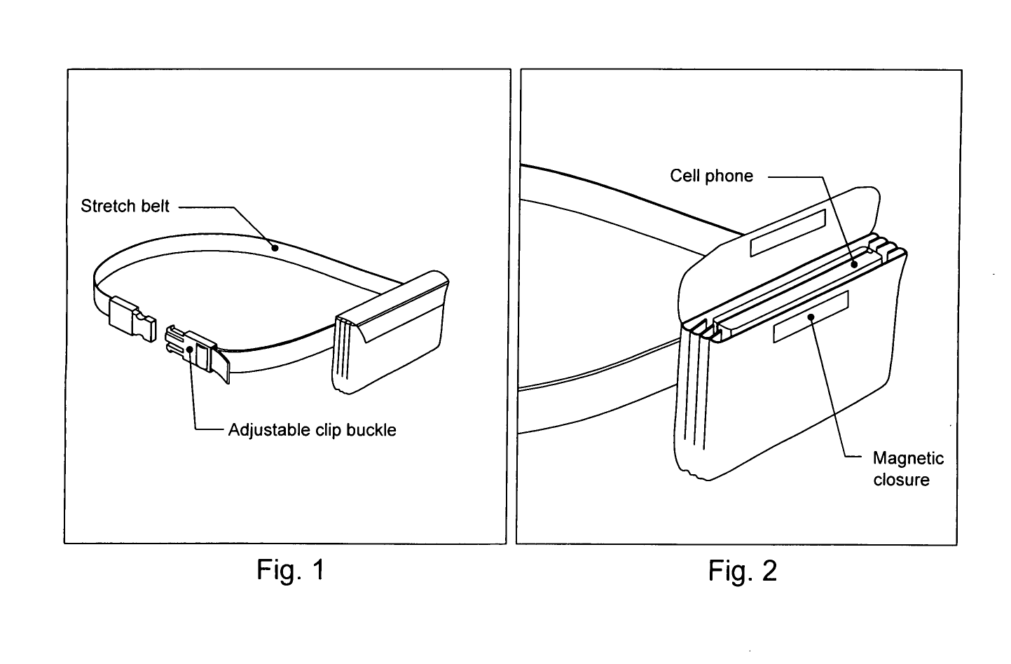

### DETAILED DESCRIPTION OF THE INVENTION

Telecommunications have played an important role in modern society. Ever improving, today's telephones are in fact mini-computers, possessing the ability to tell us who is calling, from what number and automatically returning the call with a push of a button. Although consumers will likely always have telephones in their homes, the desire to have a telephone on hand at all times has spawned the booming market of cellular communications. Today, people are using Cellular and digital telephones for multitasking activities such as getting stock quotes, e-mailing friends and colleagues, transmitting computer files, paging, checking traffic and weather reports, “surfing” the Internet, and making phone calls while on-the-go. Compact in size, most cellular phones can fit in a briefcase, purse or pocket with ease. The popularity of cell phones has enjoyed phenomenal growth in recent years. In fact, it is estimated that in the United States alone, over 180 million people have “gone wireless.” The benefits of owning a cellular phone have never been disputed. Providing stranded motorists with a means of calling for help, offering frequent travelers a means of staying in contact with loved ones, closing deals while on the road, and allowing giggling teenagers to gossip while shopping at the mall, cellular phones are an indispensable tool that millions would never be without.

Although there is little doubt that cellular telephones are extremely useful devices, they do little good if not easily accessed. Simply stated, many have experienced the frustrating scenario of hearing their phone ringing, but not being able to locate the phone in their purse or briefcase in enough time to actually receive the call. Not surprisingly, missing an important call simply because one's phone cannot be effortlessly located can be extremely frustrating. In addition, the problem of dropping and breaking one's cellular phone during use is an extreme challenge to many cellular subscribers. Specifically, many consumers store their cellular telephones in pants or shirt pockets, or in the pouches of back packs, briefcases and purses, which can be somewhat unsafe. Unfortunately, the simple act of bending over to tie a shoe can result in the cell phone falling out and crashing to the ground. As cellular telephones generally range in price from anywhere between fifty dollars to upwards of several hundred dollars for certain models, dropping a cell phone can be a costly mistake.

Recognizing the need for a device that would provide ready access to one's cellular equipment, while effectively preventing a cellular telephone from falling and breaking when stored, the present invention, hereinafter referred to as the Cell Phone Belt Pack was developed. Simply stated, the Cell Phone Belt Pack is a specially designed belt featuring an integrated storage case for use with cellular telephones, thus providing convenient and secure access for these much needed accessories. Designed to provide consumers a comfortable means of storing their cellular phones, the Cell Phone Belt Pack comprises the belt itself, a lightweight and comfortable waist belt manufactured primarily of stretchy elastic material. In addition, higher end versions of the Cell Phone Belt Pack are also available and can be manufactured of canvas, nylon or even fancy or suede leather material. In the case of more fashionable belts, the surface of the Cell Phone Belt Pack can be adorned with any number of decorative embellishments including rhinestones, beads, fringe or embroidery, to name a few options. Further, the Cell Phone Belt Pack can be produced in a myriad of stylish colors and designs, as well as more subdued neutral hues. As can be imagined, design possibilities for the Cell Phone Belt Pack are virtually limitless. This belt is produced in a range of sizes for wear by male and female consumers and can be held comfortably about the waist by means of an adjustable buckle fastener. Most notably, incorporated into the design of the Cell Phone Belt Pack is the actual cell phone holder. Reinforced, this holder is manufactured of molded and shatterproof plastic or rubber material, or can be manufactured of the same material as the belt itself and is securely attached to the surface of the belt in an easily accessed location, such as on the hip. Generally rectangular in shape and sized appropriately to accommodate the various makes and models of cellular telephones available on the market, this holder measure approximately two and three quarters inches in length by five and one half inches in width. Featuring an ample depth of one inch, this holder also features integrated storage pockets or pouches for use in storing credit and identification cards, cash or other personal items. For practical purposes, encompassing the top of this holder is a flap like covering, held closed by means of self affixing magnetic fasteners which secure the cell phone within. In this manner, the cellular telephone is easily accessed, yet safely secured in the Cell Phone Belt Pack at all times.

Use of the Cell Phone Belt Pack is very simple and straight forward. A consumer simply purchases a Cell Phone Belt Pack in accordance to the desired material, color and design. For instance, a free spirited college coed may purchase a fancy pink suede Cell Phone Belt Pack, adorned with shiny faux rhinestones. Alternately, a busy executive may desire a more understated version of the Cell Phone Belt Pack in basic black leather. In either case, the user purchases the Cell Phone Belt Pack in the desired size, donning the belt as they would any other waist belt. With the Cell Phone Belt Pack properly secured about the waist by means of the adjustable buckle fastener, the user then places their cell phone within the unit's integrated holder, securing the holder closed by means of its integrated flap covering. Safely encased within the Cell Phone Belt Pack, the cell phone can be easily retrieved whenever needed, with the user simply removing their phone from the belt and returning it following use. After use, the Cell Phone Belt Pack is removed and stored away until again needed.

The Cell Phone Belt Pack is a unique product invention which provides consumers many significant benefits and advantages. Foremost, the Cell Phone Belt Pack provides consumers ready access to their cellular phone whenever needed. A fashionable accessory, conveniently worn about the waist, the Cell Phone Belt Pack spares the cellular subscriber the hassle of digging through their purse, briefcase or backpack in order to locate their cellular phone. In addition, the clever inclusion of a covered cell phone holder ensures that one's cell phone will never drop or fall to the ground. Comfortably worn about the waist, use of this innovative product effectively prevents those accidental mishaps which often occur when the phone falls out of a pocket, holster or similar storage device. Safely containing the cellular phone within the reinforced storage unit, the Cell Phone Belt Pack provides a simple means of protecting one's expensive investment. Because of this, users of the Cell Phone Belt Pack are spared costly repairs and replacement fees that are associated with dropped cell phones. With designs ranging from simple and utilitarian to sleek and stylish, the Cell Phone Belt Pack provides a versatile product which accommodates a wide variety of consumer needs. Whether worn with a business suit, pair of jeans, or construction coveralls, the Cell Phone Belt Pack provides a functional accessory for men and women alike. Not limited to use with cellular equipment, the Cell Phone Belt Pack can also be utilized to store and access PDAs, Mp3 players, iPods and other electronic equipment, providing unfettered access to these personal electronic goods. Further, this device also provides convenient storage for currency, identification cards and other personal items, ensuring these goods can be easily accessed whenever needed. Constructed of quality materials, this product will withstand years of repeated use.

The Cell Phone Belt Pack is a stylishly designed product invention which offers a safe and efficient means of providing ready access to one's cellular telephone while protecting one's cellular telephone from potential falls. Simple to use and durably constructed, this fashionable belt proves a useful accessory for anyone who owns a cellular telephone. Affordably priced, the Cell Phone Belt Pack will be well received by the general consumer populace.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An improved device for carrying and wearing an article such as a cell phone, comprising a belt having an integrated storage case for use with cellular telephones s the actual cell phone holder, wherein the holder is manufactured of molded and shatterproof plastic or rubber material, securely attached to the surface of the belt in an easily accessed location, such as on the hip.

2. The device of claim 1 wherein the holder is generally rectangular in shape and sized appropriately to accommodate the various makes and models of cellular telephones available on the market.

3. The device of claim 2, wherein the holder measures approximately two and three quarters inches in length by five and one half inches in width and a depth of one inch.

4. The device of claim 2, further comprising one or more integrated storage pockets or pouches for use in storing credit and identification cards, cash or other personal items.

5. The device of claim 2 further comprising a flap like covering, on the top of this holder, wherein the flap is, held closed by means of self affixing magnetic fasteners which secure the cell phone within.

6. The device of claim 5 wherein the device is manufactured in any of a variety of materials including stretchy elastic material, leather, canvas, nylon, and suede in a variety of colors embellished or not embellished with rhinestones, beads, fringe or embroidery.

7. The device of claim 5 further comprising an adjustable buckle fastener.

8. The device of claim 5 manufactured in a variety of sizes.

9. The device of claim 5 wherein the holder is manufactured of the same material as the belt.

10. The device of claim 5 wherein the holder is manufactured of different material than the belt.
